(19) United States
(12) Patent Application Publication
(10) Pub. No.: US 2004/0178669 A1
(43) Pub. Date: Sep. 16, 2004

(54) Glide mount support base apparatus for child restraint car safety seat

(76) Inventors: Suzanne D. Lady, Portland, OR (US); John L. Moore, Oregon City, OR (US)

Correspondence Address: OLSON AND OLSON, 5412 SE FOSTER ROAD, PORTLAND, OR, 97206, US

(21) Appl. No.: 10/799,310

(22) Filed: Mar. 11, 2004

Related U.S. Application Data
(60) Provisional application No. 60/455,110, filed on Mar. 14, 2003.

(51) Int. Cl. B60N 2/02

(52) U.S. Cl. 297/250.1

(57) ABSTRACT

A glide mount child restraint safety car seat support base apparatus is arranged for secured disposition supported on a vehicle seat inwardly of an adjacent door opening of the vehicle, the support base apparatus telescopingly mounting a child restraint safety car seat in a first, locked, travel condition and in a second, unlocked, laterally extended loading and unloading condition in which the child restraint safety car seat is telescopically extended laterally at least partially and preferably substantially entirely through the adjacent door opening of the vehicle and there supported substantially outside of the vehicle for facilitated access for loading and unloading of the car seat by a person standing in a substantially upright, ergonomically correct lifting position outside of the vehicle.

This invention claims benefit under 35 U.S.C. 119(e) of the priority filing of U.S. Provisional application Serial No. 60/455,110; Filed: 14 Mar. 2003.

### BACKGROUND OF THE INVENTION

This invention relates generally to child restraint safety car seats and carrier assemblies, and more particularly to a support base mounting apparatus for such car safety seats and carriers arranged to selectively permit supported, laterally gliding movement of a mounted safety seat or carrier, when in an unlocked condition on the support base, for gliding movement of the safety seat from its locked, travel position on an underlying, supporting vehicle seat to a laterally extended position therefrom in which the car seat is supported in position through and substantially outside of the adjacent door opening of the vehicle for facilitated, safer, and more ergonomically correct parent loading and unloading of the car seat or carrier and its occupant between travel operations of the vehicle.

As persons familiar with transporting infants and young children in automobiles are well aware, child restraint safety car seats and carriers are a necessary and mandated requirement for protection of a young child during operation of a motor vehicle. As those persons are also aware, the loading, unloading and securing of a child in these safety restraint seats and carriers requires the person to bend at the waist and lean forwardly and awkwardly well into the interior of the car while lifting and carrying the child and/or occupied seat or carrier in those awkward, forwardly leaning positions. These bended positions are well recognized as being inappropriate and potentially harmful positions for lifting, particularly given the constantly repeating, often daily need for these operations over the span of time from a child's birth until he is capable of substantially independent embarking and debarking of a motor vehicle.

It has been found that numerous specific injuries result from lifting while bending and twisting including disc herniations and sprains, low back sprains and strains, mechanical low back pain, deleterious changes in back muscle and ligament strength and in loss of stabilizing control of the spine. Aside from the greatly increased risk of potential back injury, there is a higher risk of developing chronic back and spinal conditions as well. At its least, the required repetitive lifting while bending and awkwardly leaning and twisting involved in repeatedly loading and unloading children and car seats invariably results in unnecessary and significant physical and muscular fatigue.

U.S. Pat. No. 6,505,887 discloses an infant's restraining seat arranged to be secured on the back seat of a two door vehicle for supporting a child during travel in a locked condition and arranged, in an unlocked position, to permit the restraining seat to be pulled forwardly on the rear seat toward the front of the car and the forwardly-disposed door opening so that the child can be more easily and conveniently removed from or placed into the restraining seat without a person having to do so while also leaning well back into the back seat area of the car. This structure however does still require the person to lean into the car and towards the rear seat in order to release the locking mechanism of the safety seat and while pulling the safety seat carriage longitudinally forwardly and the carriage guide tracks arcuately toward the door opening.

U.S. Pat. No. 6,283,545 discloses an infant carrier loading apparatus arranged to allow a person to secure the base support member in the middle of a vehicle seat while providing a laterally disposed slide member arranged to permit the removable infant carrier of the assembly to be released and slid laterally over the vehicle seat towards the door opening of a vehicle whereby to facilitate placement and removal of the carrier into and out of the vehicle. This arrangement, while avoiding the need for a person to lift the carrier onto and off of the supporting base mount located in the center of a car seat, still requires the person to lean fully into the vehicle for operating the latch release mechanism and for pulling and pushing the child carrier along the tracks from the center of the car toward the adjacent door opening and vice versa.

### SUMMARY OF THE INVENTION

In its basic concept this invention provides a glide mount support base apparatus for a child restraint safety car seat or carrier arranged for secured disposition on a vehicle seat, the glide mount support base apparatus mounting a child restraint safety car seat in a first, locked, travel condition and in a second, unlocked, laterally extended loading and unloading condition in which the child restraint safety car seat is telescopically extended laterally to a position extended at least partially, and preferably substantially entirely through an adjacent door opening of the vehicle for facilitated access for loading and unloading by a person standing in a substantially upright, ergonomically correct lifting position outside of the vehicle.

It is by virtue of the foregoing basic concept that the principal objective of this invention is achieved; namely, the provision of a child restraint safety car seat support glide mount which overcomes the limitations and disadvantages associated with child restraint safety car seats and carriers of the prior art and provides for more ergonomically correct operation by an operator.

Another object of this invention is the provision of a child restraint safety car seat glide mount support base apparatus of the class described which may also mount a child restraint safety car seat member rotatably on a laterally extensible glide structure for rotation of the safety seat thereon to further facilitate easy and convenient loading and unloading operations.

Another object of this invention is the provision of a child restraint safety car seat glide mount support base apparatus of the class described which may be arranged to releasably and directly mount a child restraint safety car seat provided in the form of an infant carrier unit for quick release attachment and detachment from the base support glide mount apparatus.

Still another object and advantage of this invention is the provision of a child restraint safety car seat base support apparatus which may be of simplified construction for economical manufacture.

The foregoing and other objects and advantages of the present invention will appear from the following detailed description, taken in connection with the accompanying drawings of preferred embodiments.

### BRIEF DESCRIPTION OF THE DRAWINGS

FIG. 1 is a fragmentary side elevation of a glide mount support base apparatus embodying features of this invention shown secured on a vehicle seat and mounting an infant car seat and carrier apparatus having its own base member and releasably interconnected carrier member.

FIG. 2 is a perspective view of the safety seat glide mount support base apparatus of FIG. 1 in a locked, travel condition and with the infant carrier apparatus omitted, parts otherwise hidden from view being shown in broken lines.

FIG. 3 is a perspective view similar to FIG. 2 but showing the glide mount support base apparatus in an extended, loaded and unloading position.

FIG. 4 is a fragmentary top plan view of the assembly of FIG. 1 showing the apparatus in its extended, loading and unloading condition.

FIG. 5 is a fragmentary top plan view of the apparatus shown in FIG. 4 but illustrated in its locked, retracted travel condition.

FIG. 6 is a fragmentary side view of another embodiment of the glide mount support base apparatus of this invention illustrating that the seat mount may directly mount a car seat member, which mount may be a releasably lockable mount, and that the base support assembly may be provided in the form of the base unit component of a complete infant car seat/carrier assembly.

FIG. 7 is a fragmentary sectional view illustrating an alternative embodiment of telescopically extensible glide support arrangement and turntable arrangement.

FIG. 8 is a fragmentary side elevational view illustrating yet another embodiment of a telescopically extensible glide support arrangement and turntable assembly.

### DESCRIPTION OF THE PREFERRED EMBODIMENTS

At the outset it is to be understood that although a child restraint safety car seat is being illustrated herein in the form of an infant car seat carrier and support base combination, those acquainted with the art will readily recognize that there are many other styles and types of child restraint safety car seats that are provided depending on the desired seating arrangement and the different sizes, ages and weights of child occupants ranging from birth until such time as these aids are no longer needed or the child is self-sufficient in tending to his own embarking, debarking and securement needs for traveling in the motor vehicle. Therefore it is to be understood that the car seat assembly 10, 12 illustrated herein, and the use of the term “child restraint safety car seat” throughout this disclosure and claims is to represent and identify any and all forms of child restraint safety car seat arrangement.

With the foregoing thus understood, a child restraint safety car seat 10 is shown in the form of an infant safety car seat carrier combination having a carrying handle 10′, the car seat being removably mounted by well known releasable lock means (not shown) to a corresponding support base unit 12 normally supported on and fixedly secured to a vehicle's seat 14 in long known well-recognized manner such as by engagement of the support base unit 12 by the seat belt assembly (not shown) of the vehicle extending from the junction of the vehicle seat 14 and seat back 16. Alternatively, these base units 12 are also arranged for securement to the vehicle-mounted safety car seat restraint means such as the securing components of a LATCH (Lower Anchors and Tethers for CHildren) restraint system being provided in newer model vehicles and as will be described shortly.

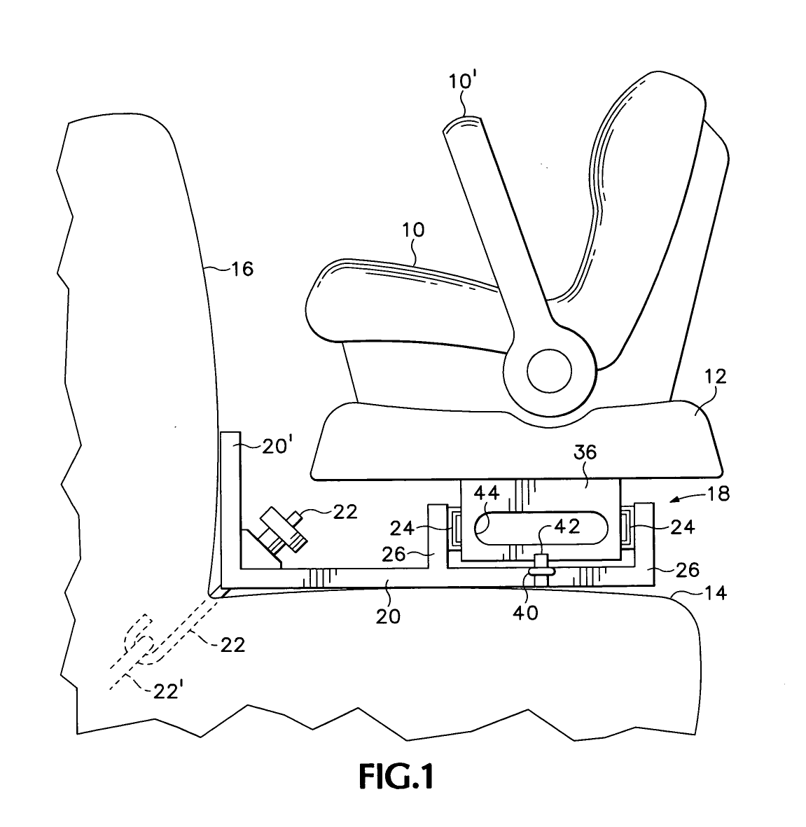

FIGS. 1-5 illustrate a first embodiment of the glide mount support base apparatus 18 of the present invention in a simplified form for ease of understanding and arranged for mounting a car seat and carrier combination 10, 12 of typical and well known construction. In this regard, the glide mount support base apparatus 18 comprises a base support member 20 configured for disposition on and support by an underlying seat 14 of a vehicle. Means is provided for securely interconnecting the base member 20 and a safety restraint apparatus of the vehicle for positively securing the glide mount support base apparatus 18 against the possibility of dislodgement from the vehicle seat 14 as is well understood. In the particular embodiment illustrated herein, the base support member 20 mounts, at a longitudinally rearward end thereof, LATCH attachment members 22 shown herein as hook members arranged for positive connection to the corresponding LATCH attachment members 22′ secured to the vehicle and extending typically between the seat bottom 14 and seat back 16 of the motor vehicle. Alternatively, the base member 20 may be configured, as by the provision of an upstanding rear longitudinal end portion 20′ or other suitable arrangement, for properly receiving and being captured by a car seat belt assembly (not shown) secured thereabout in the same manner as has long been known in the securement of child safety car seat assemblies to vehicle seats. Any suitable and lawful securement arrangement for positively securing the glide mount support base apparatus of this invention in place supported on a car seat is also contemplated herein.

Means is provided for interengaging the base member 20 and a child restraint safety seat 10 for lateral, telescopically extensible gliding movement of the safety car seat between a first, secured, travel position disposed over the base member 20 and a second laterally extended position in which the car seat is extended laterally from the base member 20 at least partially through the adjacent door opening of the motor vehicle and supported in position substantially outside of the vehicle for loading and unloading. In the present embodiment, telescopically extensible glide support means is provided by telescopically extensible glide track members 24 secured to upstanding glide track supports 26 extending laterally across the base member 20.

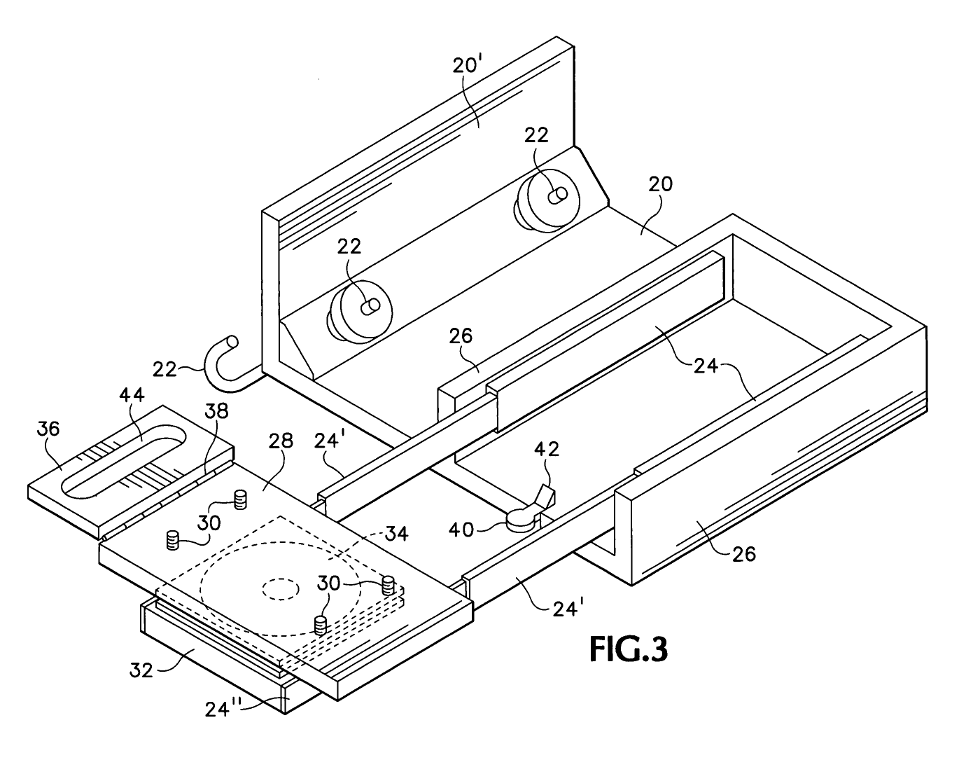

As is evident from the drawings, these telescopically extensible glide track members 24 are preferably generally similar in overall construction to conventional drawer glides for mounting pull out drawers in cabinetry, wherein, as seen best in FIG. 3 of the drawings, a first track member 24 is mounted fixedly in laterally disposed condition on the base member 20 and telescopically mounts an extensible inner track member section 24′ for supported movement telescopically into and out of the track section 24. Preferably the inner track sections 24′ are provided for low friction movement relative to the supporting track portion 24 such as by the provision of low friction bearing material therebetween or by the provision of roller supports between the inner telescoping track 24′ and the outer support track 24 as is well known in the provision of telescopic glide assemblies such as drawer glides, etc. As is typical, the glide members include interengaging stops (not shown) to prevent over-extension and separation of the telescoping members 24′ from the members 24.

Means is provided for mounting a child restraint safety car seat to the telescopically extensible glide track members 24′ for support and movement therewith. In the preferred form shown herein, the telescopically extensible glide track members 24′ mount at their outer terminal end portions 24″, seat mount means, illustrated for simplicity in this embodiment as seat support platform 28 configured to support and mount a car seat and carrier base unit 12. In this regard, mounting bolts 30 are illustrated herein as secured to the seat mount platform 28 and arranged to extend through corresponding bores (not shown) through the bottom of a carrier support base unit 12 for clamped securement thereof by corresponding nuts (not shown). While this arrangement is intended to be illustrative of one suitable mounting arrangement, it is to be understood that any other suitable, alternative seat mount attachment arrangement may of course be provided as needed or desired.

Preferably, although not necessarily, the seat mount means is mounted for rotation on the laterally extensible, telescoping glide support members 24′. In the embodiment illustrated, the outer terminal end portions 24″ of the extensible glide member sections 24′ fixedly mount an interconnecting turntable base member 32 which in turn mounts the bottom of a turntable assembly 34. The child restraint safety car seat mount support platform 28 is in turn mounted to the top of the turntable assembly 34. In its preferred form, the turntable assembly 34 is of the roller bearing type for strength and unrestricted, substantially friction free rotation of a child restraint safety car seat assembly and its occupant supported therein.

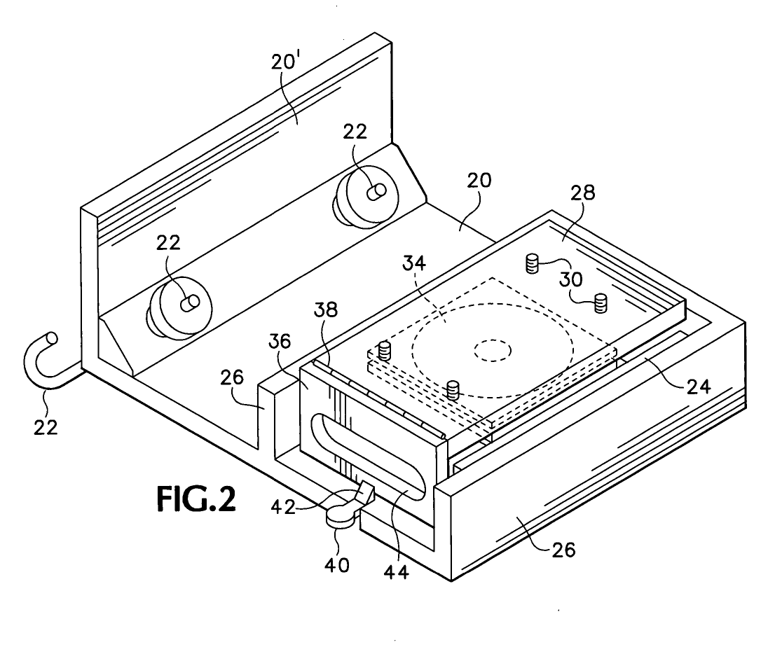

Lock means is provided for interconnecting the child restraint safety car seat mount means (platform 28 in this particular embodiment) and the base support member 20 for releasably locking the seat mount against rotation and laterally gliding extension movement on the base support member when the assembly is in its first, secured, travel condition shown in FIGS. 1, 2 and 5 of the drawings. This releasable lock means is illustrated herein as lock handle member 36 secured to the seat mount platform 28 by pivot hinges 38 as seen best in FIGS. 2 and 3.

As can be readily seen, when the glide mount base assembly is in its first, retracted, travel condition of FIG. 2 and the lock handle 36 is pivoted on its hinged mount 38 to the seat mount 28 into the downwardly extended condition disposed between the uprights 26, the seat mount base 28 is fixed against rotational movement on the turntable by abutment of the lateral sides of the lock handle member 36 against the uprights 26 of the base support member 20. As previously indicated, means is also provided for releasably securing the child restraint safety car seat in travel condition and against unintended lateral gliding movement on the base support member 20.

In this regard, latch means, shown herein as flexibly tensioned, finger depressable catch member 40, is provided on the base support member 20 for releasably abutting engagement of a lock tab 42 against the face of the lock handle member 36 for abuttingly securing the handle member in the downwardly extended, locked condition of FIG. 2 and against pivoting movement on its pivot hinges 38. In this manner, the latch assembly 40, 42 not only releasably locks the handle assembly in position preventing rotation of the turntable, but also provides an abutment stop against the handle which securely locks the assembly in its travel condition of FIG. 2 and against outward, lateral gliding movement of the assembly supported on the telescopically extensible glide track members 24, 24′.

As those skilled in the art will readily recognize, when the catch member 40 is depressed, the abutting lock tab 42 is displaced out of abutting engagement with the face of the lock handle member 36, allowing an operator to grasp the handle member (facilitated by the provision of finger slot opening 44) and pivot the lock handle member 36 upwardly about its hinge mount 38 and then simply pull the assembly laterally on the supporting, extensible glide track members toward and through the adjacent door opening A of the vehicle, rotating the assembly, as in FIG. 3, as needed or desired for convenience in loading and unloading.

From the foregoing and the views of FIGS. 1-5 it will be readily appreciated by those skilled in the art that even in the simplified form shown the glide mount base support apparatus of this invention is arranged to permit substantially one handed operation of its locking, unlocking, rotating and gliding functions by an operator grasping only the locking handle member which is poitioned conveniently immediately adjacent the door opening A of the vehicle, and further that all lifting and child tending requirements of the operator may be conducted entirely outside of the vehicle and immediately in front of the operator with the child restraint safety car seat supported by the base member and glide support at a height substantially equal to or greater than the level of the car seat above an underlying ground level upon which the operator is standing. Thus the operator is able to remain in a substantially upright, ergonomically correct standing position substantially throughout the entire loading and unloading process without ever having to lean into the vehicle compartment for any back-straining operation.

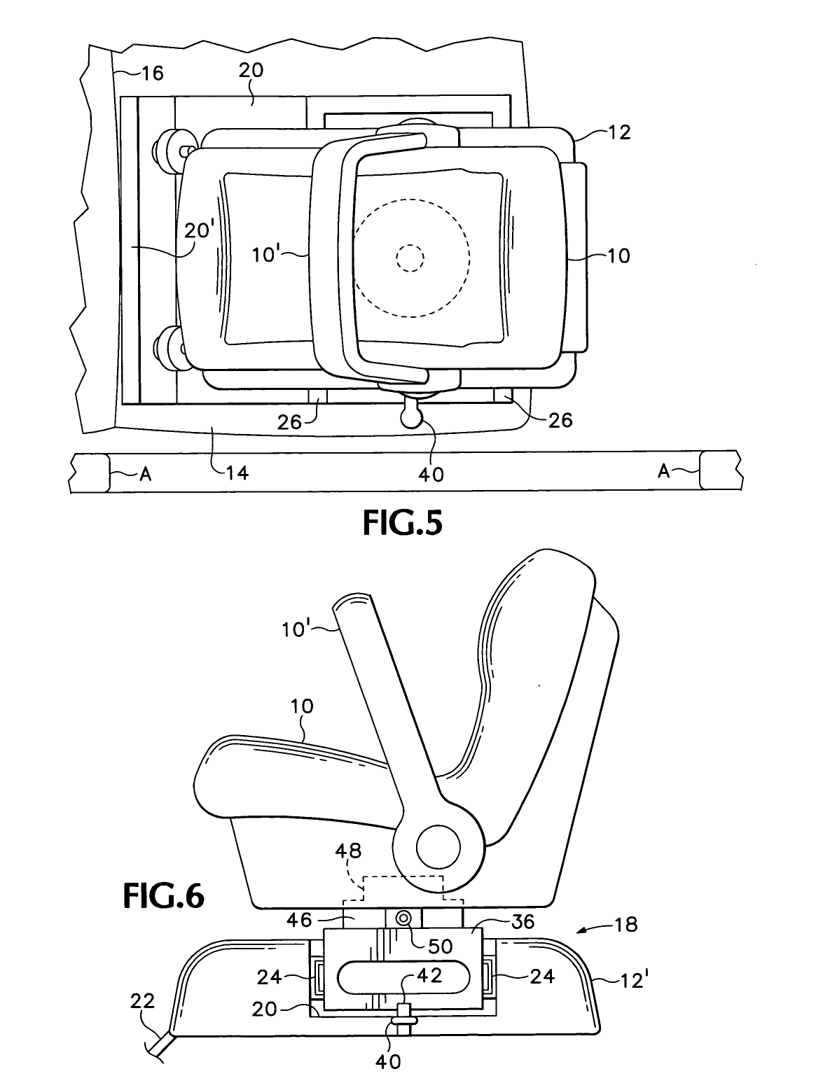

FIG. 6 illustrates a second embodiment of the glide mount support base apparatus of this invention arranged to mount a child restraint safety car seat directly. In this regard, the aforementioned structural elements previously described in connection with the embodiment of FIGS. 1-5 may be substantially similar or identical if desired, with the exception that the seat mount means previously described in the form of seat mount platform 28 with securing bolts 30, is provided in the form of a seat mount member 46 configured as needed for fixed attachment on the turntable assembly 34 and glide track members 24′ for directly engaging and securing a desired child restraint safety car seat 10 thereto. This seat mount member 48 may be of a type providing a fixed, non-detachable securement for a child restraint safety car seat of the type not intended to be removed with the child, as in the case of safety car seats and safety booster seats for toddlers and young children that are too large for practical use of carrier seats, etc.

Alternatively, the seat mount member 46 may be provided in the form of a base component 46 of a two component, releasably lockable coupler assembly such as those well known and long used in infant car seat and carrier assemblies 10, 12 as shown in FIG. 1. In this regard, the base component 46 is configured to lockably engage with a corresponding second coupler component 48 secured to the removable carrier 10 through an interengaging latch mechanism typically having a latch lock release member 50 operable to temporarily unlock the coupler lock components to permit intended separation of the carrier 10 from its supporting base 12. These carrier-to-base coupler arrangements are well known in the industry and therefore need not be described in closer detail herein.

With the foregoing thus understood, FIG. 6 also therefore illustrates that the glide mount base support apparatus 18 of this invention may form the support base unit of a complete fixed child restraint safety car seat assembly, or may form the base unit 12′ of a complete infant car seat and carrier assembly 10, 12′. As discussed previously, it may also be provided in the form of the first embodiment of FIGS. 1-5 as an individual glide mount support base assembly for use with other, separately-marketed, complete child restraint safety car seat and/or carrier assemblies 10, 12 for adapting and retrofitting other previously purchased or independently marketed car seat assemblies for the more ergonomically-correct use and operation afforded by the present invention.

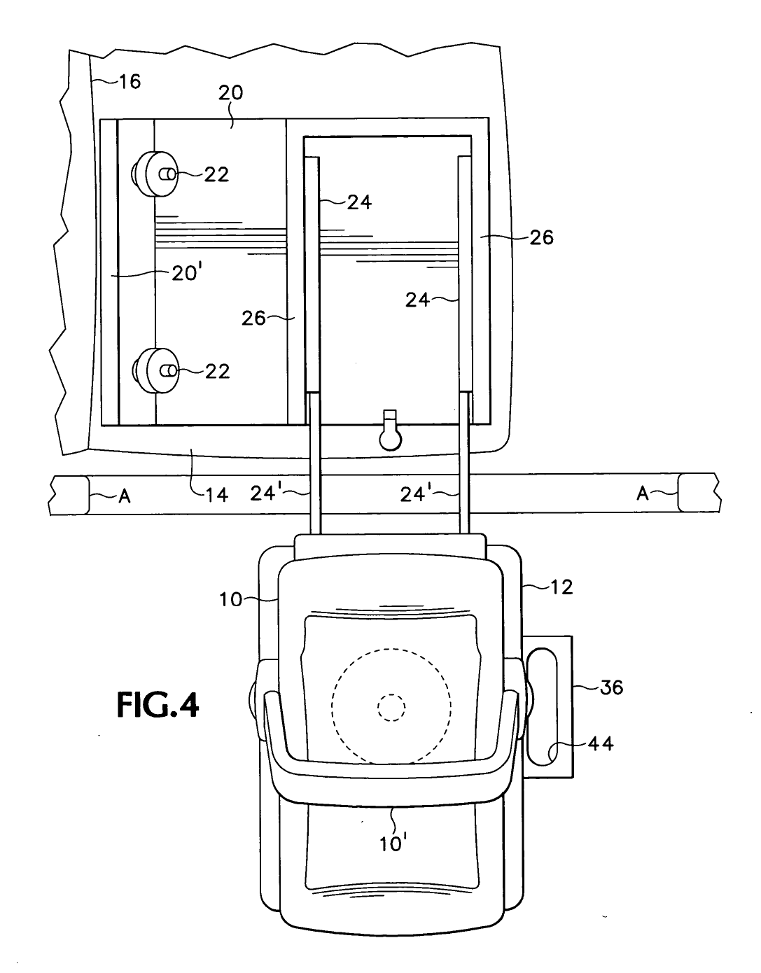

With the glide mount support base apparatus of this invention disposed on a vehicle car seat inwardly from a door opening of the vehicle and secured on the vehicle seat by an appropriate restraint system (LATCH system, seat belt assembly, etc.), and a selected type of child restraint safety car seat mounted on the seat mount of the apparatus, the operation and use of the glide mount support base apparatus is as follows: The user grasps the handle member which is preferably located on the assembly conveniently facing and adjacent to the door opening of the vehicle, and depresses the lock catch lever to release the handle member and associated glide assembly from its locked travel condition supported directly over the base member (FIGS, 1, 5). The user then pulls gently on the handle member to extend the assembly on the telescoping glide track members laterally from the base member to a position in which the child restraint safety car seat is extended at least partially and preferably substantially fully through the door opening of the vehicle and disposed at least partially and preferably substantially entirely outside of the vehicle (FIG. 4). The assembly may be rotated (as in FIG. 4) as desired for most convenient orientation of the car seat relative to the user standing alongside the car for loading of the child onto the safety car seat or, in the case of the use of a removable infant car seat carrier, loading of the occupied carrier onto the base unit 12, 12′. The user then grasps the handle and glides the assembly telescopically back into the vehicle interior into the assembly's travel condition (FIGS. 1, 5) whereupon the handle member is pivoted into its downwardly extending condition and captured by the locking tab of the lock catch. The apparatus and child are thus safely secured for travel operation of the motor vehicle. The unloading operation of the assembly is substantially the same, excepting that the child is removed from the assembly extended outside of the car.

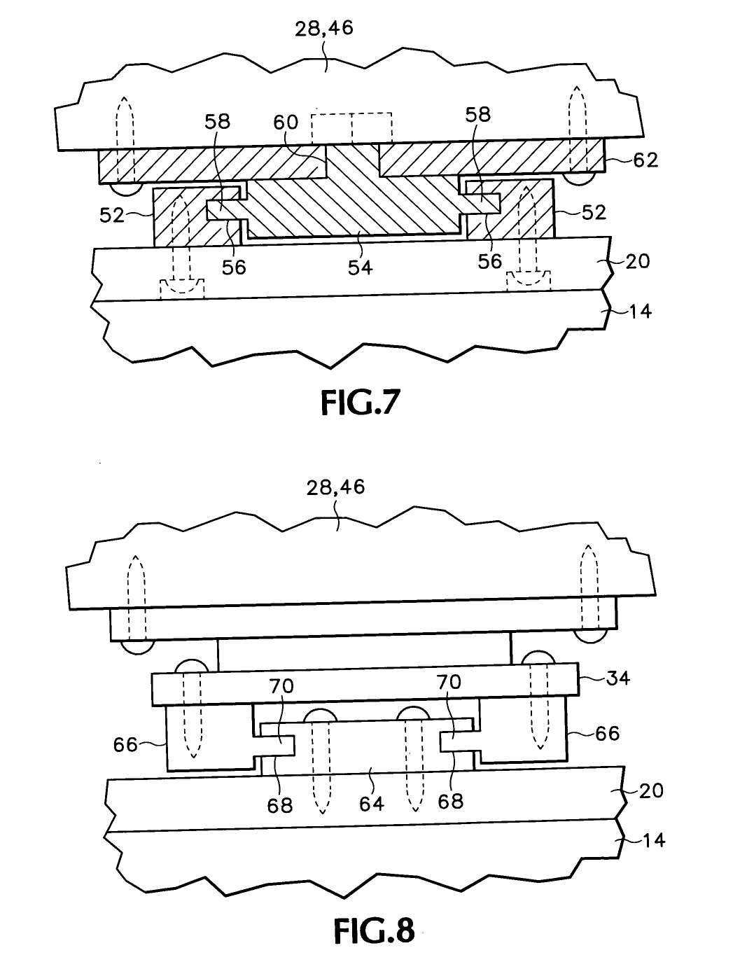

FIG. 7 illustrates an alternative embodiment of a telescopically extensible glide support means and turntable means suitable for the purpose. In this, the base support member 20 fixedly mounts a pair of longitudinally spaced-apart, longitudinally elongated, laterally extending glide support members 52 arranged to glidingly receive and support an intermediately-spanning, longitudinally elongated telescopically extensible glide member 54, as by slidingly-corresponding, interengaging longitudinally extending guide grooves 56 and flanges 58. The telescopically extensible glide member 54 in this embodiment is provided, as by projecting spindle shaft 60, to rotatably mount and secure a rotatable turntable disc member 62 to which a desired seat mount 28, 46 is in turn mounted.

FIG. 8 illustrates yet another alternative embodiment of telescopically extensible glide support means and turntable means suitable for the purpose. In this, the base support member 20 fixedly mounts a longitudinally elongated, laterally extending central glide support member 64 arranged to glidingly receive and support a pair of outer longitudinally elongated, telescopically extensible glide members 66 for telescopic movement laterally relative to the base member 20, as by corresponding, interengaging guide grooves 68 and flanges 70. The telescopically extensible glide members 66 mount the base of a turntable assembly 34, the top of which mounts a desired seat mount 28, 46.

From the foregoing description of various embodiments and alternative structural means, it will be apparent to those skilled in the art that the various structural elements and arrangements shown and described herein are merely illustrative of structural elements and arrangements suitable for the purposes they are intended, and that many various changes, other than those already shown and described may be made in the size, shape, type, number and arrangement of parts described hereinbefore without departing from the spirit of this invention and the scope of the appended claims.

Having thus described our invention and the manner in which it may be used, we claim:

1. A glide mount child restraint safety car seat support base apparatus for supporting a child restraint safety car seat assembly on the seat of a vehicle in a first, secured travel position and in a second, unlocked loading and unloading position extended laterally through an adjacent door opening of the vehicle for facilitated loading and unloading of the child restraint safety car seat assembly disposed substantially outside of the vehicle compartment, the glide mount child restraint safety car seat support base apparatus comprising:
a) a base member arranged for secured disposition on a vehicle seat laterally inwardly from an adjacent door opening of the vehicle,
b) securement means on the base member for engaging a safety restraint apparatus of the vehicle for securing the base member in substantially fixed, secured disposition on the vehicle seat,
c) seat mount means for mounting a child restraint safety car seat assembly,
d) telescopically extensible glide support means for interengaging said base member and said seat mount means for mounting said seat mount means for laterally telescoping extension movement on the base member between a first, retracted, travel position in which the seat mount means and a child restraint safety car seat assembly mounted thereon substantially overlies the base member, and a second, laterally-telescoped, extended loading and unloading position in which the seat mount means and a child restraint safety car seat assembly mounted thereon is telescopically extended laterally from the base member and at least partially through the adjacent door opening of the vehicle and supported by the base member and glide support means for loading and unloading of the child restraint safety car seat assembly substantially outside of the vehicle compartment, and
e) locking means for releasably securing the telescopically extensible glide support means in said first, retracted, travel position in which said seat mount means substantially overlies the base member.

2. The glide mount child restraint safety car seat support base apparatus of claim 1 wherein said seat mount means is mounted for rotation on said telescopically extensible glide support means, and means for releasably locking the seat mount means against rotation interconnects the seat mount means and the base member for releasably securing the seat mount means against rotation when said telescopically extensible glide support means is secured in its said first, retracted travel condition for operation of the vehicle.

3. The glide mount child restraint safety car seat support base apparatus of claim 1 wherein said seat mount means comprises a first seat mount coupler member arranged for releasably locking interengagement with a corresponding second coupler member on a child restraint safety car seat assembly for secure, locked mounting and facilitated, unlocked detachment of a child restraint safety car seat assembly for use of the detached safety car seat as a child carrier.

4. The glide mount child restraint safety car seat support base apparatus of claim 1 wherein said seat mount means comprises a seat mount base member mounted on said telescopically extensible glide support means, the seat mount base member arranged to engage and supportably mount the support base unit of a child restraint safety car seat carrier assembly in which the support base unit detachably mounts a combined child restraint safety car seat and carrier unit.
